(19) United States
(12) Patent Application Publication
(10) Pub. No.: US 2017/0069172 A1
(43) Pub. Date: Mar. 9, 2017

(54) METHOD, SERVER AND COMPUTER PROGRAM FOR PROVIDING SPORTS BETTING SERVICE

(71) Applicant: SEUNG HWAN OH, Seongnam (KR)

(72) Inventor: SEUNG HWAN OH, Seongnam (KR)

(21) Appl. No.: 14/845,549

(22) Filed: Sep. 4, 2015

(51) Int. Cl. G07F 17/32

(52) U.S. Cl. CPC G07F 17/3288; G07F 17/3225

(57) ABSTRACT

A method of providing a sports betting service, a server and a computer program are disclosed. The method of providing a sports betting service by operating executable program commands stored in a memory using a processor in a user terminal including the processor and the memory connected to the processor, the method comprising: (a) displaying at least one bettable event in a present betting interval of betting intervals generated by dividing a game, wherein each of the betting intervals includes a betting time capable of betting and a game time capable of verifying result of the betting; (b) displaying one or more events selected from the bettable event as a betting event; (c) receiving betting money about the betting event; and (d) transmitting betting request information including at least one of the present betting interval, the betting event and the betting money to a server, wherein the bettable event includes an event capable of occurring during the game, and the sports betting service pays dividend corresponding to the betting when the betting event is occurred in the present betting interval.

### TECHNICAL FIELD

The present disclosure relates to a technique for providing a sports betting service.

### BACKGROUND ART

Interest in sports seems to have sparked lately according as interest leisure life picks up.

Generally, people enjoy sports by visiting a stadium where sports game is held or hearing or viewing broadcasting through various mediums such as a radio, a TV, Internet, etc.

Acquaintances bet based on expected result of a game, etc. and have dividend revenue according to the result of the game, thereby increasing considerably interest about the game and enjoyment of the game.

A betting game such as a toto or a proto, that analyzes and enjoy a game through interest and participation about sports, has been introduced according as people enjoying the game and the betting increase, instead of taking a gamble.

However, the conventional betting games lead users to do only betting about sports, but may not induce active participation of the users about the sports game.

That is, since the conventional betting game such as the toto or the proto predicts only victory or defeat, score, the users are interest in corresponding game until before the game starts.

However, if the game starts, it is impossible to do betting. Accordingly, interest of the users goes down, like viewing of existing game, and thus the users are interest in only dividend according to the result of the game.

Additionally, it is difficult, for users who are as green as grass in analyzing of specific team or player of the game, to do betting, and so the users may be indifferent to do the betting game.

A technique, for keeping continuously interest about the game from starting of the game to ending of the game by allowing doing betting in various cases (events) of the sports game, has been required. Moreover, a technique, for inducing interest about the betting game by providing reliable information to the user who is as green as grass in analyzing of specific team or player of the game, has been required.

The above information disclosed in this Related Art section is only for enhancement of understanding of the background of the invention and therefore it may contain information that does not form the prior art that is already known in this country to a person of ordinary skill in the art.

### SUMMARY

Accordingly, the present invention is provided to substantially obviate one or more problems due to limitations and disadvantages of the related art.

One embodiment of the invention provides a method of doing betting about various events occurred during progress of a sports game.

Another embodiment of the invention provides a method of providing reliable information useful to do betting to a user who is as green as grass in analyzing of specific team or player.

In one aspect, the present invention provides a method of providing a sports betting service by operating executable program commands stored in a memory using a processor in a user terminal including the processor and the memory connected to the processor, the method comprising: (a) displaying at least one bettable event in a present betting interval of betting intervals generated by dividing a game, wherein each of the betting intervals includes a betting time capable of doing betting and a game time capable of verifying result of the betting; (b) displaying one or more events selected from the bettable event as a betting event; (c) receiving betting money about the betting event; and (d) transmitting betting request information including at least one of the present betting interval, the betting event and the betting money to a server, wherein the bettable event includes an event capable of occurring during the game, and the sports betting service pays dividend corresponding to the betting when the betting event is occurred in the present betting interval.

In another aspect, the present invention provides a server providing a sports betting service, the server comprising: at least one hardware processor; and non-transitory computer storage medium configured to encode commands, the commands executes an operation through the server when the commands are executed by the hardware processor, and the operation includes: providing at least one bettable event in a present betting interval of betting intervals generated by dividing a game to a user terminal, wherein each of the betting intervals includes a betting time capable of doing betting and a game time capable of verifying result of the betting; receiving betting request information, including at least one of the present betting interval, a betting event which is an event selected from the bettable event and betting money about the betting event, from the user terminal; and calculating dividend based on the received betting request information and an event occurred in the present betting interval, and wherein the dividend is calculated when the betting event is occurred in the present betting interval.

In one embodiment of the invention, a user can do betting about various events occurred during progress of a sports game, and thus the user may keep continuously interest about the sports game from starting of the sports game to ending of the sports game.

Since reliable information is provided to the user who is as green as grass in analyzing of specific team or player of the game, interest about the betting game may be increased.

Effect of the invention is not to effect mentioned above, and may include every effect capable of being inferred from description or claims of the invention.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a sports betting system according to one embodiment of the invention;

FIG. 2 is a block diagram illustrating a service server according to one embodiment of the invention;

FIG. 3 is a flow chart illustrating a betting service of sports game according to one embodiment of the invention;

FIG. 4 is a flow chart illustrating a sports game betting service according to another embodiment of the invention;

FIG. 5 is a flow chart illustrating a process of calculating a prediction value about betting event according to one embodiment of the invention;

FIG. 6 is a view illustrating a betting screen of sports game according to one embodiment of the invention;

FIG. 7 is a view illustrating a betting screen of sports game according to another embodiment of the invention;

FIG. 8 is a view illustrating a betting screen of sports game according to still another embodiment of the invention; and

FIG. 9 is a view illustrating statistical information according to one embodiment of the invention.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

A section not related to description is omitted in drawings so as to describe distinctively the invention. Additionally, similar numerical number is applied to elements for performing similar function.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, it will be understood that the terms “comprises”, “comprising,”, “includes” and/or “including”, when used herein, specify the presence of stated features, integers, steps, operations, elements, and/or configurations, but do not preclude the presence or addition of one or more other features, integers, steps, operations, elements, configurations, and/or groups thereof.

Hereinafter, various embodiments of the present invention will be described in detail with reference to accompanying drawings.

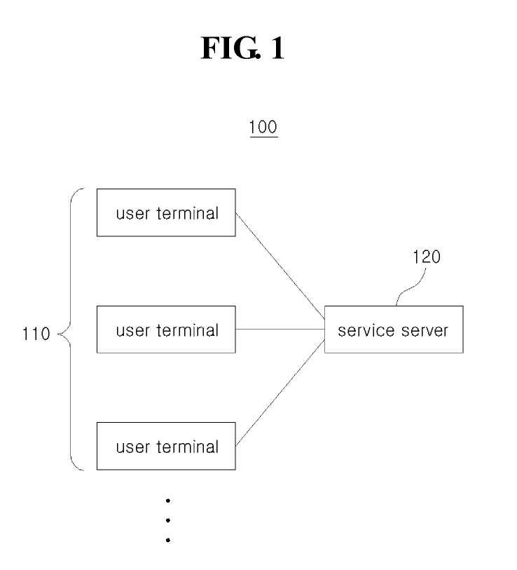

FIG. 1 is a view illustrating a sports betting system according to one embodiment of the invention.

The sports betting system 100 of the embodiment may include user terminals 110 and a service server 120.

The user terminal 110 may include a processor and a memory connected to the processor. The memory may store program commands for executing following operation of the user terminal 110 according to control of the processor.

The service server 120 may include at least one hardware processor and a non-transitory computer storage medium for encoding commands. Following operations may be performed according as the commands are executed by the processor.

The user terminal 110 may receive information concerning one or more of result prediction of a game (for example victory, tie, defeat, etc.), score prediction of a home team and an away team participating in the game, prediction of an event occurred during progressing the game in present betting interval of betting intervals generated by sectionalizing the game and prediction of item related to the event, and betting sum (betting money) according to the prediction. The user terminal 110 may transmit betting request information including to the received information and the received betting sum to the service server 120.

Here, the betting interval may differ depending on kinds of the sports.

In an example of a basketball game, plural betting intervals may be determined by dividing the basketball game based on quarters or in the unit of preset score (for example, 30 points). In this case, the betting intervals may be sectionalized to intervals of 0 to 30 point, 31 to 60 point, 61 to 90 point and 91 to 120 point.

In an example of a soccer game, plural betting intervals may be determined by dividing the first half and second half of the soccer game in the unit of preset time. In this case, the betting intervals may be sectionalized to 9 betting intervals in the first half, 9 betting intervals in the second half, i.e. total 18 betting intervals in the event that the soccer game is divided by 5 minutes.

In an example of a baseball game, plural betting intervals may be determined by dividing the baseball game on the basis of match of a pitcher and a hitter every inning.

On the other hand, the user terminal 110 may display one or more bettable events on a screen or display at least one an item selectable by the user on the screen, in every betting interval.

Here, each of the betting intervals may include a betting time for the betting and a game time where the user can verify his betting result after the betting time is finished.

For example, in the event that total time (90 minutes) of the first half and the second half in the soccer is divided by five minutes, each of the betting intervals (18 betting intervals) may include the betting time of 1 minute and the game time of 4 minutes.

The users may select events, predicted to be occurred in the present betting interval, of bettable events during one minute, and verify with interest their betting result (success or failure of the betting) with watching the game during four minutes.

Here, the event may include events occurred while the sports game is being progressed.

In an example of the basketball game, the event may include shooting, rebound, score, foul, turn-over, block shot, steal, intercept, etc.

In an example of the soccer game, the event may include goal, drawing, corner kick, warning, offside, foul, penalty kick and so on.

In an example of the baseball game, the event may include strike out, bunt, fly, four ball, hit by pitch, hitting, double play, homerun, balk of a pitcher, etc., and include further steal of a runner and so on.

Kinds of the event for the sports game are not limited as examples mentioned above, but the event may includes various events capable of being occurred while the sports game is being progressed.

Furthermore, the event may include location of a ball moved by passing of players, etc. in the basketball game and the soccer game, location of players taking responsibility for specific position, whether score of a team is even number or odd number, event occurred while a pitcher is matched with a hitter, and event not occurred directly by present pitcher and present hitter such as steal of a runner, etc.

That is, the event may events occurred according to a rule of the sports game and every event occurred while the sports game is being progressed such as playing and location of the ball and the players, whether the score is odd number or even number and so on.

The user may select at least one event (hereinafter, referred to as “betting event”) desiring to do betting in the home team or the away team of bettable events displayed on the screen of the user terminal 110 in the present betting interval, or select whether the selected betting event is occurred in the home team or the away team.

In an example of the soccer game, goal, drawing, corner kick, warning, offside, foul and penalty kick may be shown as the bettable events, and the user may select the goal, the corner kick and the offside, as the betting event, of the bettable events, for each of the home team and the away team.

Of course, the betting event for the home team may not be identical to that for the away team, i.e. different event may be selected depending on the home team or the away team.

The bettable event may be displayed to select whether the ball locates an area of the home team or an area of the away team based on a half line in the present betting interval, and the user may select the area of the home team or the area of the away team as the betting event.

In the basketball game, scoring, foul and event as to whether the score is odd number or even number may be displayed as the bettable event in the present betting interval, and the user may select the event as to whether the score is odd number or even number.

That is, the user may select whether the scores of the home team and the away team correspond to even number and even number, even number and odd number, odd number and odd number, and odd number and even number in the present betting interval.

Additionally, the bettable event may include No event that no event is predicted to be occurred in the present betting interval.

In an example of the soccer game, goal, drawing, corner kick, warning, offside, foul, penalty kick and No event may be displayed as the bettable event. In the event that the user selects the No event as the betting event, it is determined that the betting is succeed if any one of goal, drawing, corner kick, warning, offside, foul and penalty kick is not occurred in corresponding betting interval, and then the dividend may be paid to the user.

The bettable events are the same as in every betting interval, or the betting event in specific betting interval is different from that in the other betting interval.

In view of paying the dividend, the dividend may be paid to the user if an event occurred first of the betting events selected by the user exists in corresponding betting interval.

In an example of the soccer game, in the event that the user selects offside and warning as the betting event, dividend for the betting event may be paid to the user if offside is first occurred in the present betting interval.

However, in the event that goal not selected by the user is first occurred in the present betting interval, the dividend for the betting event may not be paid.

In another embodiment, in the event that the user selects one or more betting events in the present betting events, the dividend for the betting event may be paid if every betting event selected by the user is occurred in the present interval.

In an example of the soccer game, in the event that the user selects goal, corner kick and warning in the present betting interval, the dividend may not be paid if the events occurred in the present interval are corner kick, warning and offside, and this is because every betting event selected by the user is not occurred.

In another embodiment, in the event that some of the betting events are occurred, only dividend for the occurred betting event may be paid.

In an example of the soccer, in the event that the user selects goal, corner kick and warning as the betting event in the present betting interval and corner kick, warning and the offside are occurred in the present betting interval, the dividend corresponding to the occurred corner kick and warning (hit betting event) may be paid.

Additionally, the user may select an item with the betting event in each of the betting intervals.

Here, the item means detailed occurrence types of the event. Plural items may exist for one event.

In an example of the basketball game, in the event that the event is score, two-point shot, three-point shot, a player making a score first, etc., may be provided as the items. Moreover, in the event that the event is foul, foul of a defense player, foul of an offense player, team foul, foul number, etc. may be provided as the items.

In an example of the baseball game, in the event that the event is fly, infield fly, sacrifice fly, foul fly, simple fly, etc. may be provided as the items.

In the event that the event is hitting, left front hit, center front hit, two-base hit, three-base hit, hit number, etc. may be provided as the items.

In the event that the event is strike out, pitch number of the pitcher for the strike out may be provided as the item.

The user may select one or more items (hereinafter, referred to as “select item”) of selectable items displayed on the screen of the user terminal 110.

In the event that the selected item is hit in the present betting interval, compensation corresponding to hit of the item may be provided.

Here, hit of corresponding event should be first realized before the hit of the selected item, and compensation corresponding to the hit of the selected item may include one or more of increase of betting rank classified depending on betting success rate, paying of preset point, paying of points corresponding to preset number of times of present point of the user and providing of a character.

Statistical information may be displayed on the screen of the user terminal 110 so as to increase betting success rate when the user selects the bettable event and the selectable item provided in the present betting interval.

The statistical information may include at least one of a statistical value and a prediction value.

The statistical value may be calculated by using past game data of the home team and the away team being matched currently, and players belongs to the teams. The prediction value may be calculated by past betting parameter, current betting parameter and environment parameter of each of the bettable events.

Here, the past betting parameter may be determined by using past betting data about the event in each of betting groups classified in an order of the betting success rate. The current betting parameter may be calculated by using current betting data about the event in each of the betting groups. The environment parameter may be determined by using one or more of past game place, a number of spectators, weather, game time, game record and upturn or downturn of the team and the players according to the game record.

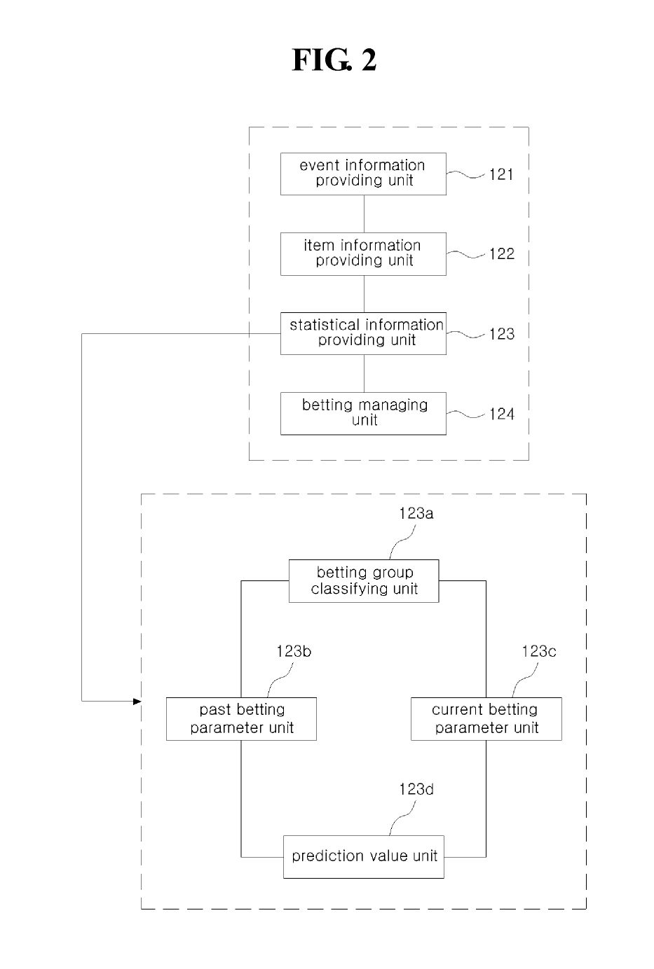

Detailed description concerning the parameters used for calculating the prediction value will be described with reference to FIG. 2.

The user terminal 110 may search one or more of betting total sum of corresponding user for each of the events, betting sum by the user, total betting sum of the betting event betted by the user (including betting sum of other users), dividend rate, dividend, total sum betted for an event which the user does not bet and dividend rate.

The user terminal 110 may include a mobile terminal, such as a smart phone, a portable phone, a PDA, a PMP, a tablet computer, etc., and a television connected to a laptop computer, a desktop computer, a set-top box, etc. The user terminal 120 may be connected to the service server 120 through wire communication or wireless communication.

The service server 120 may provide a betting screen of the sports game, and provide information (for example, game date, name of the home team and the away team, current score, etc.) concerning a game to be progressed or a progressing game to the user terminal 110, according to request of the user terminal 110.

The service server 120 may provide a list of the bettable events and a list of the selectable items in each of the betting intervals to the user terminal 110.

Since the bettable event, the betting event, the selectable item and the select item are described above, any further description concerning the events and the items will be omitted.

The service server 120 may provide the statistical information useful to select the event or the item to the user terminal 110.

Here, the statistical information may include one or more of the statistical value and the prediction value. The statistical value and the prediction value will be described in detail with reference to accompanying FIG. 2.

The service server 120 may receive betting request information including at least one of present betting interval, the betting event selected by the user, the select item and betting sum (money) from the user terminal 110, and do betting by using the received betting request information.

Here, the betting request information may include further other information depending on kind of the sports game. In an example of the baseball game, the betting request information may include further information (name, etc.) of the pitcher and the hitter being matched in the present betting interval.

The service server 120 may pay dividend corresponding to betting in the event that an event occurred first of the betting events selected by the user in the present betting interval exists.

The service server 120 may pay dividend corresponding to betting in the event that every of the betting event selected by the user in the present betting interval is succeed or at least one of the selected betting event is succeed.

The service server 120 may pay compensation corresponding to a selected item when the item selected by the user in the present betting interval is hit.

The service server may provide one or more of total betting sum for every event of the user requesting search, betting sum of corresponding user, total betting sum of the event betted by corresponding user (including betting sum of the other users) and dividend rate, dividend when the betting is hit, and total sum betted to an event not to betted by corresponding user and dividend rate, to the user terminal 110.

The system of the invention may provide various compensations helpful to use the betting service as well as dividend, through betting for various events capable of being occurred in the sports game being progressed currently and selecting of the item, as well as betting of the sports game to be progressing.

The system may provide the reliable statistical information (statistical value and prediction value) useful to select the event or the item to the user who is not accustomed to the betting game.

FIG. 2 is a block diagram illustrating a service server according to one embodiment of the invention.

The service server 120 of the embodiment may include an event information providing unit 121, an item information providing unit 122, a statistical information providing unit 123 and a betting managing unit 124.

The event information providing unit 121 may divide sports game into plural betting intervals, and provide a list of bettable events to the user terminal 110 in individual betting interval.

Here, the betting intervals may differ depending on kind of sports game, which is described above with reference to FIG. 1.

Since the bettable event and the betting event are described above, any further description concerning the events will be omitted.

The item information providing unit 122 may provide a list of selectable items corresponding to the betting event to the user terminal 110, according to the betting event selected by the user.

Since relation of the betting event and the selectable item, the select item and the compensation are described above, any further description concerning the event, the item and the compensation will be omitted.

The statistical information providing unit 123 may provide the statistical information useful to select the betting event or the item in the present betting interval to the user terminal 110.

Here, the statistical information may include at least one of the statistical value and the prediction value for the bettable event shown in the present betting interval.

The statistical information providing unit 123 may calculate the statistical value on the basis of past game data of a home team and an away team being matched currently and players in the teams.

In the baseball game, the statistical information providing unit 123 may calculate the statistical value for an event or an item occurred when a pitcher and a hitter were matched, based on past game data of the pitcher and the hitter being matched currently.

The statistical information providing unit 123 may calculate the prediction value, based on one or more of past betting success number about bettable event of the users participating in the present betting interval, current betting number and the past game data.

The statistical information providing unit 123 may include a betting group classifying unit 123a, a past betting parameter unit 123b, a current betting parameter unit 123c and a prediction value unit 123d.

Hereinafter, elements of the statistical information providing unit 123 will be described in detail.

The betting group classifying unit 123a may classify members of the sports betting service provided by the service server 120 into groups (hereinafter, referred to as “betting group”), based on betting success rate.

This is because the betting success rate differs depending on the user.

Here, the betting success rate may be determined by using preset number or more of betting number and predetermined rate or more of hit number, in a past betting record.

Weight may be applied to calculate the prediction value for groups.

For example, in the event that the betting groups are classified to high rank betting group, middle rank betting group and low rank betting group according to the betting success rate, 0.5, 0.3 and 0.2 of weights may be respectively applied to high rank betting group, middle rank betting group and low rank betting group.

Of course, the betting groups may be classified in more detail, and different weight way may be applied to the betting groups.

Hereinafter, it is assumed that the betting groups are classified to good, fair and poor and 0.5, 0.3 and 0.2 of weights are respectively applied to high rank group, middle rank group and low rank group.

The betting group classifying unit 121 may interwork with a database for storing betting information of the users, e.g. betted events, betting number, betting success rate, etc.

The past betting parameter unit 123b may calculate the past betting parameter, based on past betting hit number of the betting group about bettable event in the present betting interval.

Weight may be applied to the past betting parameter when the prediction value is calculated.

The current betting parameter unit 123c may calculate current betting parameter, on the basis of current betting number of the betting group about the bettable event in the present betting interval.

Weight may be applied to the current betting parameter when the prediction value is calculated. Betting result of the betting group in the present betting interval may be used for calculating past betting parameter in next betting interval.

In an example of the baseball game, the betting result of the betting group about matching of A pitcher and B hitter in the present betting interval (first betting interval) may be used for calculating the past betting parameter in next betting interval (second betting interval) in the event that the A pitcher and the B hitter are again matched.

The prediction value unit 123d may calculate the prediction value about the bettable event in the present betting interval, based on the parameters calculated by the past betting parameter unit 123b and the current betting parameter unit 123c.

The prediction value unit 123d may apply the past betting parameter and the current betting parameter to weights. Here, the weight for the past betting parameter may be higher than that for the current betting parameter.

For example, weight of 0.6 may be applied to the past betting parameter, and the weight of 0.4 may be applied to the current betting parameter.

This is because the past betting parameter is a statistical value based on past data, i.e. the statistical value about an event occurred already, and the current betting parameter is a prediction value about an event not occurred yet.

The prediction value unit 123d may reflect further the environment parameter to the prediction value.

Here, the environment parameter may include external factors such as past game place, number of spectators, weather, game time, etc. and internal factors such as upturn or downturn of power of a team or players according to game record, etc.

In an example of the soccer game or the baseball game, if winning rate of A team is high when it is cloudy or the game was progressed in specific game place, the environment parameter for the A team may become higher in the event that the game is progressed in the specific game place or it is cloudy.

In the soccer game, if specific player of position FW in the A team increases in recent in effective shooting number and assist, the environment parameter for the specific player may get higher in score or the assist.

The prediction value unit 123d may calculate the prediction value reflecting various environment parameters, about teams being matched currently and players in the teams.

The prediction value unit 123d may reflect the environment parameter to the past betting parameter or to sum of the past betting parameter and the current betting parameter.

The statistical information providing unit 123 may provide the statistical information for the selectable item, to select usefully the item.

Since the statistical information of the selectable item is substantially similar to that of the bettable event, any further description concerning the statistical information will be omitted.

The betting managing unit 124 obtains information concerning events occurred in the present betting interval in the event that game time of the present betting interval is over.

The betting managing unit 124 may discriminate whether the betting event is hit through the betting request information transmitted from the user terminal 110 and pay dividend corresponding to the betting sum and compensation according to hit of the selected item.

The betting managing unit 124 may pay dividend corresponding to the betting in the event that an event occurred first in the present betting interval exists.

The betting managing unit 124 may pay dividend corresponding to hit event in the event that every events of the betting events selected in the present betting interval is hit or at least one of the selected betting event is hit.

The betting managing unit 124 may updates betting information (betting number, whether the betting is hit, dividend, etc.) of the user in the event that the present betting interval is finished, and update the betting group to which the user belongs.

For example, in the event that a betting group in low rank betting group satisfies classification standard of middle rank betting group according as the user in the low rank betting group hit the event in the present betting interval, the betting managing unit 124 may update (level up) the betting group from the low rank betting group to the middle rank betting group.

Level update of the betting group may be performed depending on the betting result whenever the betting interval is finished, or be performed after the game is over.

Success rate of the betting event and hit of the select item may be included in the classification standard of the betting group.

The betting managing unit 124 may provide statistical information concerning one or more of bettable events and selectable items provided in next betting interval to the user terminal 110, when the present betting interval is finished.

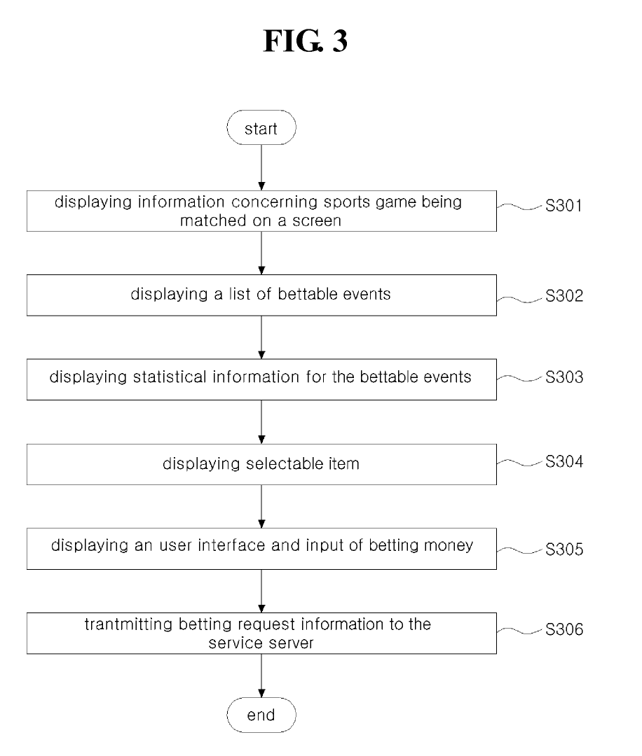

FIG. 3 is a flow chart illustrating a betting service of sports game according to one embodiment of the invention.

A process in FIG. 3 may be performed by the user terminal 110.

In a step of S301, the user terminal 110 displays information concerning at least one sports game being matched currently.

In a step of S302, in the event that the user selects specific sports game through the information displayed on a screen, the user terminal 110 displays game information concerning the selected sports game and a list of bettable events in the present betting interval on the screen.

In a step of S303, in the event that the user inputs request of statistical information, the user terminal 110 receives the statistical information including at least one of a statistical value and a prediction value for the bettable events in the present betting interval from the service server 120, and displays the received statistical information on the screen.

In a step of S304, in the event that the user selects a betting event, the user terminal 110 displays the selected betting event and a list of selectable items in the selected betting event on the screen.

Here, statistical information including one or more of a statistical value and a prediction value for the selectable items may be displayed on the screen according to request of the user.

In a step of S305, in the event that the user selects specific item of the selectable items, the user terminal 110 displays the selected item, displays a user interface for input of betting sum, and then receives the betting sum inputted by the user.

The betting sum may be paid through various ways such as online payment, cyber money, point, etc.

In a step of S306, the user terminal 110 transmits betting request information including at least one of the selected betting event, the selected item and betting sum about the selected betting event to the service server 120.

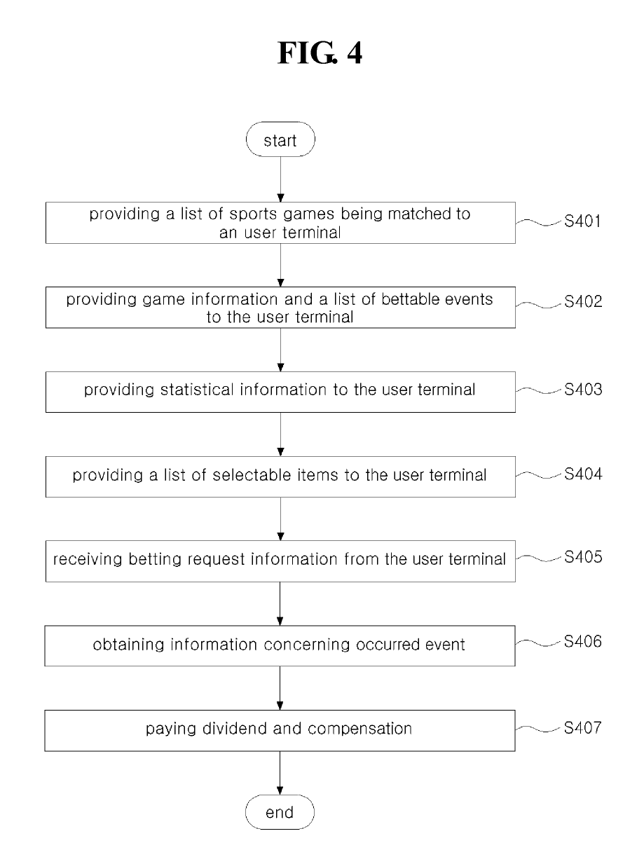

FIG. 4 is a flow chart illustrating a sports game betting service according to another embodiment of the invention.

A process in FIG. 4 may be performed by the service server 120.

In a step of S401, the service server 120 transmits a list of sports games being matched currently to the user terminal 110 according to request of the user terminal 110.

Here, one or more sports games may be progressing, the list may include one or more of names of a home team and an away team in each of the sports games, game date, game time and progress of the sports games.

In a step of S402, in the event that the service server 120 receives information concerning select of specific sports game from the user terminal 110, it transmits game information concerning the selected sports game and a list of bettable events in the present betting interval to the user terminal 110.

In a step of S403, in the event that the service server 120 receives request of the statistical information about the bettable events from the user terminal 110, it calculates the statistical information including at least one of the statistical value and the prediction value for the bettable events in the present betting interval, and then transmits the calculated statistical information to the user terminal 110.

In a step of S404, in the event that the service server 120 receives information concerning the selected betting event from the user terminal 110, it transmits a list of selectable items in the selected betting event to the user terminal 110.

In the event that the service server 120 receives request of statistical information about the selectable items from the user terminal 110, it may transmit the statistical information including one or more of a statistical value and a prediction value for the selectable items to the user terminal 110.

In a step of S405, the service server 120 receives the betting request information including at least one of the present betting interval, the selected betting event, the selected item and the betting sum from the user terminal 110.

In a step of S406, in the event that the present betting interval is finished, the service server 120 obtains information concerning an event occurred in the present betting interval.

In a step of S407, the service server 120 pays dividend corresponding to the betting and compensation corresponding to hit of the select item, in the event that an event occurred first of betting events selected by the user in the present betting interval exists.

In the event that the service server 120 receives request of information about the betting result from the user terminal 110, it transmits information as to whether the selected betting event and the selected item are hit, information concerning dividend in accordance with dividend rate, etc. to the user terminal 110.

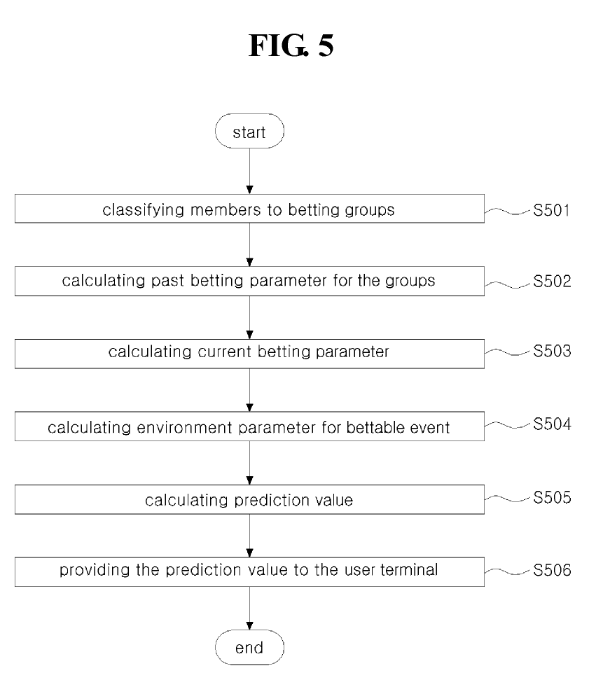

FIG. 5 is a flow chart illustrating a process of calculating a prediction value about betting event according to one embodiment of the invention.

In a step of S501, the service server 120 classifies members of the sports game betting service into a high rank betting group, a middle rank betting group and a low rank betting group, based on betting success rate.

In a step of S502, the service server 120 calculates past betting parameter for the bettable event in each of betting groups participating to betting in the present betting interval, on the basis of past betting hit number of corresponding betting group about the bettable event.

In a step of S503, the service server 120 calculates current betting parameter for the bettable event in each of the betting groups participating to betting in the present betting interval, based on current betting number of corresponding betting group about the bettable event.

In a step of S504, the service server 120 calculates environment parameter about the bettable event in the present betting interval by using the external factors and the internal factors, etc.

In a step of S505, the service server 120 calculates the prediction value for the bettable event in the present betting interval, based on the calculated past betting parameter, the calculated current betting parameter and the calculated environment parameter.

Here, the service server 120 may apply weights to the past betting parameter and the current betting parameter, wherein the weight of the past betting parameter may be higher than that of the current betting parameter.

The environment parameter may be reflected to the past betting parameter or sum of the past betting parameter and the current betting parameter when the environment parameter reflects to the prediction value.

In a step of S506, the service server 120 provides the prediction value for the bettable event in the present betting interval to the user terminal 110, according to request of the statistical information from the user terminal 110.

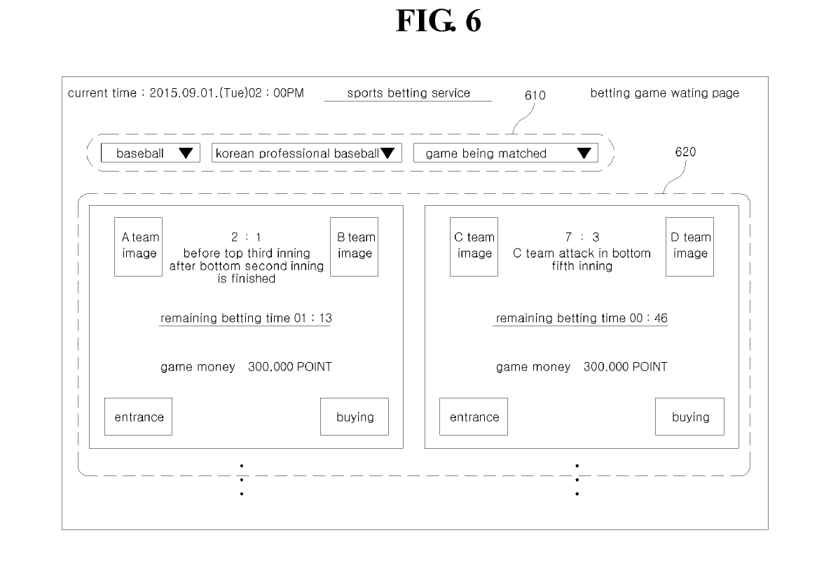

FIG. 6 is a view illustrating a betting screen of sports game according to one embodiment of the invention.

FIG. 6 shows the betting screen of the sports game provided by the service server 120. The user may select sports (baseball, soccer, basketball, etc.) and a game (national game, foreign game, etc.) desired to do betting through a select item 610.

The user may search sports game being progressed currently or sports game to be progressed through the select item 610.

In FIG. 6, national professional baseball game progressing currently is selected, and result 620 of the national professional baseball game is displayed.

In the result 620, progress state of the game may be shown briefly as illustrated in FIG. 6.

The user may enter the game by purchasing game money or selecting specific game, and then do betting with watching the game in real time.

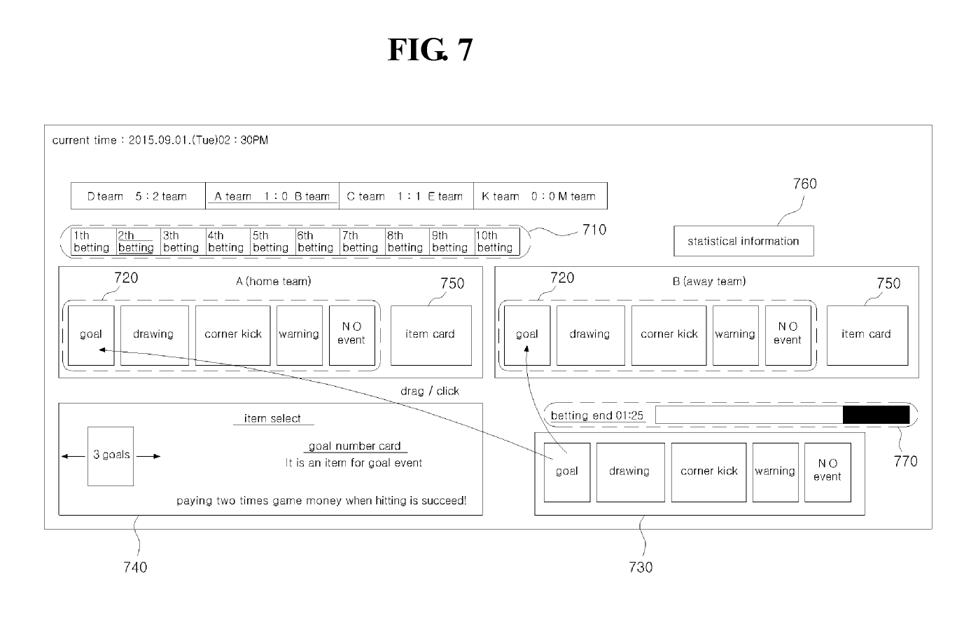

FIG. 7 is a view illustrating a betting screen of sports game according to another embodiment of the invention.

FIG. 7 shows the betting screen of a soccer game. A list of games being progressed currently may be displayed on an upper side of the screen. The game shown in detail on the screen is a game of A team and B team.

Total 10 betting intervals generated by dividing game time (first half time 45 minutes and second half time 45 minutes, i.e. total 90 minutes) by 9 minutes are displayed on a betting interval area 710 of the upper side of the screen.

A list of bettable events (goal, drawing, corner kick, warning, No event) in the present betting interval is displayed on a bettable event area 730.

The user may select one or more, in each of the home team and the away team, of the bettable events displayed on the bettable event area 730, and then select the betting event by dragging the selected event into a betting event area 720 of the home team or the away team or clicking the selected event.

No event as the bettable event may be displayed on the bettable event area 730. In the event that the No event is selected, the betting is succeed if no event of the bettable events provided in the present betting interval is not occurred.

The user terminal 110 may display a list 740 of the selectable items on the screen, and the user may select one or more of the selectable items. The selected item may be displayed on a select item area 750.

The selectable item is included in the bettable event, and goal number (three goals) as one of occurrence types related to an event ‘goal’ as the bettable event is selected in FIG. 7.

A player scoring first goal or position of the player may be further included as the selectable item for the event ‘goal’ in the list.

In one embodiment, an item predicting total number sum of events occurred in the betting intervals may be provided.

For example, an item predicting total number sum of goal or corner kick in a first betting interval to a fifth betting interval may be selected, or an item predicting total number sum of warning in a sixth betting interval to final betting interval may be selected.

In the event that the user selects a statistical information display area 760 related to the bettable event, the user terminal 110 may provide a statistical value based on past game data of the home team and the away tem being progressed currently and a statistical value about each of teams or each of players.

The prediction value generated by further reflecting the past betting parameter, the current betting parameter and the environment parameter to the statistical value may be provided when the betting event or the item is selected.

The user terminal 110 may display betting time capable of doing betting in the present betting interval on an area 770 in FIG. 7.

In FIG. 7, total 10 betting intervals are generated by dividing the first half and the second half of the game by 9 minutes. The betting time in the present betting interval (second betting interval) is 2 minutes, and remaining betting time of 1 minute 25 seconds exists in the present betting interval.

In the event that the betting time is over, the users may verify their betting result with watching the game during the remaining time of 7 minutes.

In the event that the betting time is over, game time (7 minutes) capable of verifying the betting result is displayed on the screen. Here, the remaining time may be realized with a rod-type interface as shown in FIG. 7, wherein a black section in the interface reduces gradually according as the remaining time gets lower.

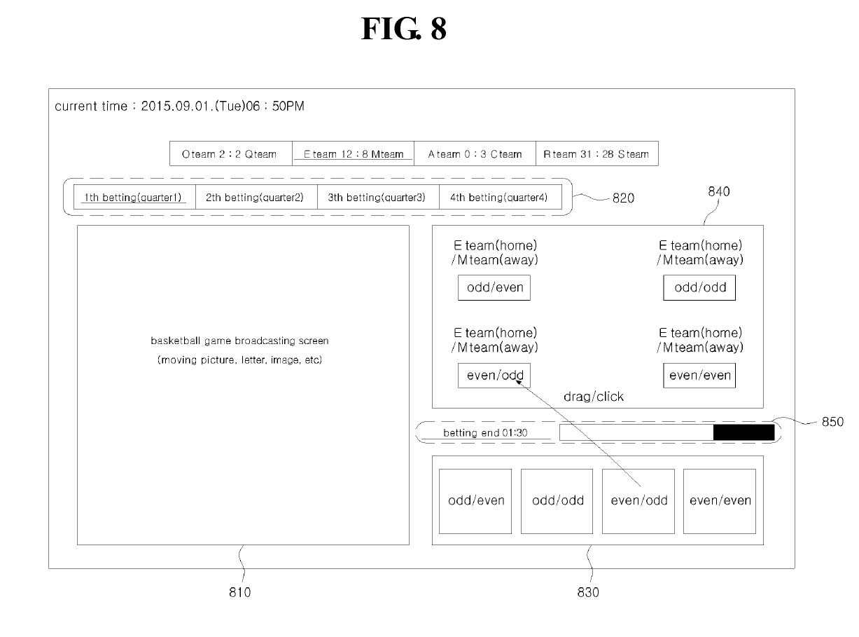

FIG. 8 is a view illustrating a betting screen of sports game according to still another embodiment of the invention.

FIG. 8 shows the betting screen of the basketball game. Progress state of the basketball game is displayed on a game broadcasting area 810. The betting intervals are generated based on a quarter.

The user selects an odd/even score event predicting whether score of each of the home team and the away team is odd number or even number in a present quarter displayed on a quarter area 820.

Progress of the game including one or more of a moving picture, a letter and an image may be displayed on the game broadcasting area 810.

In one embodiment, in the event that the image of the game is not displayed due to error of a broadcasting device, instable broadcasting transmission/reception according to worsening weather or absence of broadcasting right, etc., current progress of the game may be shown with the letter on the game broadcasting area 810.

In another embodiment, information concerning specific player or information concerning progress of the game such as foul, etc. may be displayed with the image of the game on the game broadcasting area 810.

Of course, the moving picture, the letter and the image may be together displayed on the game broadcasting area 810.

The user may predict whether each of scores of the home team and the away team is odd number or even number in the present quarter, select desired card in a card select area 830 and then drag or click the selected card on a select card area 840.

For example, in the event that the user selects even-even, dividend may be paid to the user if scores of the home team and the away team are 24:20 when a first quarter as current quarter is over.

If the user selects even-odd, the dividend is not paid to the user.

A betting time (betting over time) capable of betting in the current quarter (first quarter) may be displayed on an area 850. In the event that the betting time is over, game time capable of verifying the betting result may be displayed on the area 850.

A betting money input area for inputting betting money may be further displayed, which is not shown in FIG. 8.

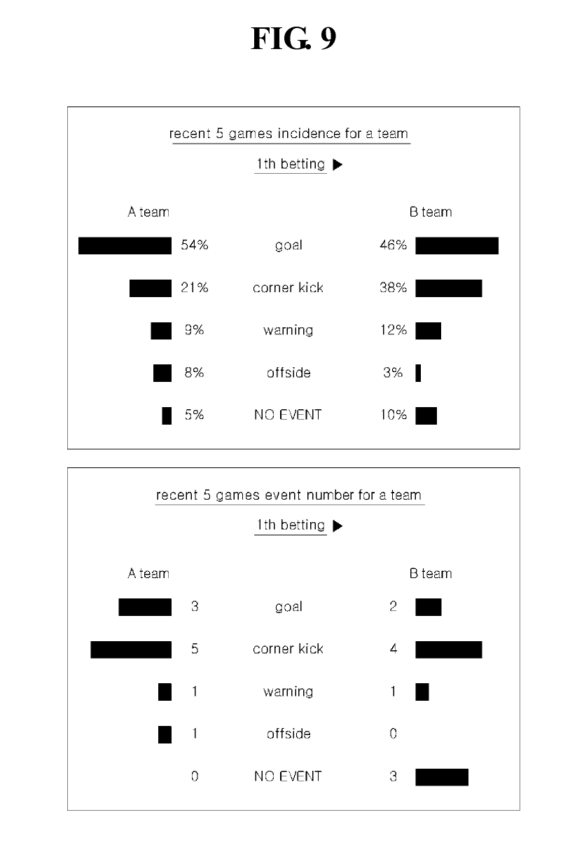

FIG. 9 is a view illustrating statistical information according to one embodiment of the invention.

FIG. 9 shows statistical information for soccer game. The statistical information may include at least one of the statistical value and the prediction value for the bettable event and the selectable item as described above.

FIG. 9 illustrates the statistical value for the bettable event. Occurrence rate and number, etc. for each of the events in individual team may be provided by using the past game data.

The users may select the bettable event by using the statistical information shown in FIG. 9.

The prediction value about the bettable event may be calculated by the past game data, further the past betting parameter, the current betting parameter and the environment parameter. The users may select the bettable event considering the calculated prediction value.

Although embodiments have been described with reference to a number of illustrative embodiments thereof, it should be understood that numerous other modifications and embodiments can be devised by those skilled in the art that will fall within the spirit and scope of the principles of this disclosure.

Accordingly, embodiments described above are examples of the invention, and thus the invention is not limited to the embodiments.

For example, element in a body may be modified to separated elements, and separated elements may be realized with combined element.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the configuration parts and/or arrangements of the subject combination arrangement within the scope of the disclosure, the drawings and the appended claims. In addition to variations and modifications in the configuration parts and/or arrangements, alternative uses will also be apparent to those skilled in the art.

### DESCRIPTION OF REFERENCE NUMBERS

100: sports game betting system
110: user terminal
120: service server
121: event information providing unit
122: item information providing unit
123: statistical information providing unit
123a: betting group classifying unit
123b: past betting parameter calculating unit
123c: current betting parameter calculating unit
123d: prediction value calculating unit
124: betting managing unit

1-14. (canceled)

15. A method of providing a sports betting service by operating executable program commands stored in a memory using a processor in a user terminal including the processor and the memory connected to the processor, the method comprising:
(a) displaying at least one bettable event in a present betting interval of betting intervals generated by dividing a game, wherein each of the betting intervals includes a betting time capable of doing betting and a game time capable of verifying result of the betting;
(b) displaying one or more events selected from the bettable event as a betting event;
(c) receiving betting money about the betting event; and
(d) transmitting betting request information including at least one of the present betting interval, the betting event and the betting money to a server,
wherein the bettable event includes an event capable of occurring during the game, and
the sports betting service pays dividend corresponding to the betting when the betting event is occurred in the present betting interval.

16. The method of claim 15, wherein in the step of (a), the betting interval is generated by dividing a first half and a second half of the game by specific time when the game is a soccer game, the betting interval is generated by diving the game by a quarter or specific score when the game is a basketball game, and the betting interval is generated by dividing the game according to matching of a pitcher and a hitter in each of inning when the game is a baseball game.

17. The method of claim 15, wherein the dividend is paid when the betting event is first occurred in the present betting interval, when every betting event is occurred in the present betting interval, or when at least one of the betting events is occurred in the present betting interval.

18. The method of claim 15, wherein the step of (a) includes:
displaying statistical information about the bettable event,
and wherein the statistical information includes at least one of a statistical value and a prediction value,
the statistical value is calculated based on one or more of past game data of a home team, an away team and players in the teams,
the prediction value is calculated based on at least one of past betting success number about the bettable events of users participating to the betting in the present betting interval, current betting number and the past game data of the home team and the away team.

19. The method of claim 18, wherein the prediction value includes a past betting parameter reflecting the past betting success number and a current betting parameter reflecting the current betting number,
the past betting parameter is calculated based on a past betting success number about the bettable event in past game of the teams in individual betting group, and wherein the betting groups are classified according to betting success rate and different weights are applied to the betting groups,
the current betting parameter is calculated based on a current betting number about the bettable event in the present betting interval, in individual betting group, and
the weight of the past betting parameter is higher than the weight of the current betting parameter.

20. The method of claim 15, wherein the step of (b) includes:
displaying at least one selectable item in the present betting interval in the event that the bettable event is selected; and
displaying an item selected from the selectable item as a select item,
the step of (d) includes:
adding the select item to the betting request information and transmitting the betting request information to the server, wherein the selectable item includes one or more of occurrence types of the betting event and compensation provided to the user,
and wherein the compensation is provided when the select item is hit in the present betting interval,

21. The method of claim 20, wherein the compensation includes increase of betting rank classified depending on an order of betting success rate, paying of specific point, paying of points corresponding to preset number of times of present point of the user and providing of a character.

22. A computer program stored in a medium including commands for performing the method of claim 15.

23. A server providing a sports betting service, the server comprising:
at least one hardware processor; and
non-transitory computer storage medium configured to encode commands,
the commands executes an operation through the server when the commands are executed by the hardware processor, and
the operation includes:
providing at least one bettable event in a present betting interval of betting intervals generated by dividing a game to a user terminal, wherein each of the betting intervals includes a betting time capable of doing betting and a game time capable of verifying result of the betting;
receiving betting request information, including at least one of the present betting interval, a betting event which is an event selected from the bettable event and betting money about the betting event, from the user terminal; and
calculating dividend based on the received betting request information and an event occurred in the present betting interval,
and wherein the dividend is calculated when the betting event is occurred in the present betting interval.

24. The server of claim 23, wherein the dividend is calculated when the betting event is first occurred, when every betting event is occurred or when at least one of the betting events is hit, in the present betting interval.

25. The server of claim 23, wherein the operation further including:
providing one or more selectable items in the present betting interval to the user terminal in the event that the betting event is selected in the user terminal,
and wherein the betting request information includes information concerning a select item which is an item selected from the selectable item,
the selectable item includes at least one of occurrence types of the betting event and compensation provided to the user, and the compensation is provided when the select item is hit in the present betting interval.

26. The server of claim 23, wherein the operation further including:
generating statistical information including one or more of a statistical value and a prediction value for the bettable event and providing the generated statistical information to the user terminal, and
the step of generating the statistical information includes:
calculating the statistical value based on one or more of past game data of a home team, an away team and players in the teams; and
calculating the prediction value based on at least one of past betting success number about the bettable events of users participating to the betting in the present betting interval, current betting number and the past game data of the home team and the away team.

27. The server of claim 26, wherein the step of generating the statistical information further includes:
calculating a past betting parameter reflecting the past betting success number and a current betting parameter reflecting the current betting number,
and wherein the past betting parameter is calculated based on a past betting success number about the bettable event in past game of the teams in individual betting group, and wherein the betting groups are classified according to betting success rate and different weights are applied to the betting group,
the current betting parameter is calculated based on a current betting number about the bettable event in the present betting interval, in individual betting group, and
the weight of the past betting parameter is higher than the weight of the current betting parameter.

28. The server of claim 27, wherein the step of generating the statistical information further includes:
calculating the prediction value using environment parameter,
and wherein the environment parameter is calculated based on one or more of past game place, number of spectators, weather, game time, game record, and upturn or downturn of individual team and individual player according to the game record,
the prediction value is calculated by reflecting the calculated environment parameter to the past betting parameter or by reflecting the calculated environment parameter to sum of the past betting parameter and a current betting parameter.

29. A computer program stored in a medium including commands for performing the operation of claim 23.
